(19) United States
(12) Patent Application Publication
(10) Pub. No.: US 2012/0311421 A1
(43) Pub. Date: Dec. 6, 2012

(54) SERVER DEVICE AND METHOD

(75) Inventor: Kazuo TOMONO, Kawasaki (JP)

(73) Assignee: FUJITSU LIMITED, Kawasaki-shi (JP)

(21) Appl. No.: 13/462,690

(22) Filed: May 2, 2012

(30) Foreign Application Priority Data
May 30, 2011 (JP) 2011-121057

(51) Int. Cl. G06F 17/00

(52) U.S. Cl. 715/208

(57) ABSTRACT

A server device includes: a number-of-instructions counting unit to count a number of instructions of a user for a link of a web page; an instruction rate predicted value calculating unit to calculate a predicted value of a rate of the instructions; a link attention specifying unit to specify an attention degree of the link based on the number of instructions and the predicted value of the rate; and a layout changing unit to change a layout of the web page based on the attention degree of the link.

### CROSS-REFERENCE TO RELATED APPLICATION(S)

This application is based upon and claims the benefit of priority of the prior Japanese Patent Application No. 2011-121057, filed on May 30, 2011, the entire contents of which are incorporated herein by reference.

### FIELD

The embodiments discussed herein are related to a server device and method for creating web content.

### BACKGROUND

Various types of content are provided on web pages, and content that suits user's preference may be selected.

Examples of the related art are disclosed in International Publication Pamphlet No. WO2004/097654, Japanese Laid-open Patent Publication No. 2001-188792, Japanese Laid-open Patent Publication No. 2004-348241, Japanese Laid-open Patent Publication No. 2003-308339, and so forth.

### SUMMARY

According to an aspect of the invention, a server device includes: a number-of-instructions counting unit to count a number of instructions of a user for a link of a web page; an instruction rate predicted value calculating unit to calculate a predicted value of a rate of the instructions; a link attention specifying unit to specify an attention degree of the link based on the number of instructions and the predicted value of the rate; and a layout changing unit to change a layout of the web page based on the attention degree of the link.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary system;

FIG. 2 illustrates an exemplary hardware configuration;

FIGS. 3A to 3C illustrate an exemplary link, an exemplary number of clicks, and an exemplary rate;

FIGS. 4A to 4C illustrate an exemplary process of calculating predicted values of click rates;

FIG. 5 illustrates an exemplary predicted values of click rate;

FIGS. 6A to 6C illustrate an exemplary process of calculating an attention degree of a link;

FIG. 7 illustrates an exemplary keyword extraction process;

FIGS. 8A and 8B illustrate an exemplary process of specifying the degrees of importance of keywords;

FIG. 9A illustrates an exemplary process of changing a layout of a web page;

FIG. 9B illustrates an exemplary layout of a web page;

FIG. 10 illustrates an exemplary system; and

FIG. 11 illustrates an exemplary process.

### DESCRIPTION OF EMBODIMENTS

For example, a “click” may be an example of an “instruction”. Examples of an “instruction” may include a click on a mouse and a tap on a touch panel. For example, an instruction may include a process of pressing an enter key in a state where a link or button has been focused on using a tab key in a web page. A click may include an “instruction” to make a user interface available.

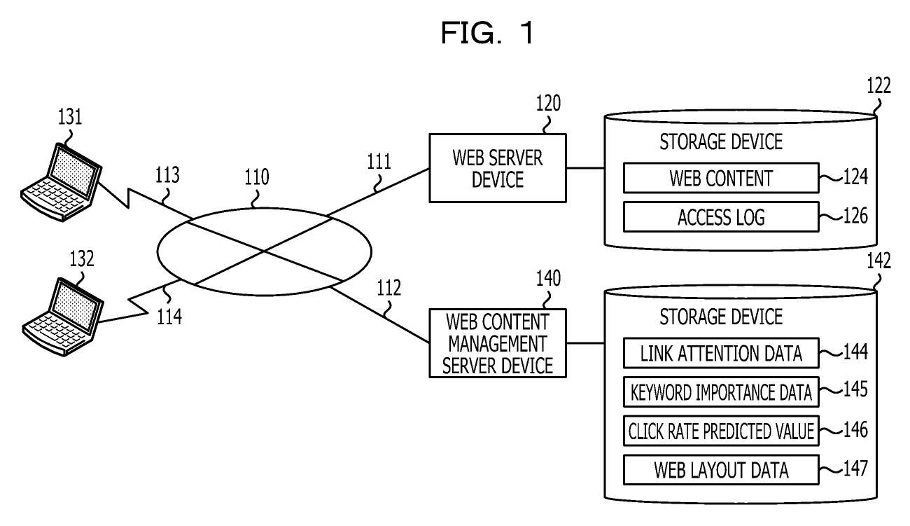

FIG. 1 illustrates an exemplary system. A system 100 includes a web server device 120 to which a storage device 122 is coupled, a web content management server device 140 to which a storage device 142 is coupled, a client 131, a client 132, and a network 110. The web server device 120, the web content management server device 140, and the clients 131 and 132 are coupled to the network 110 via lines 111 to 114, respectively.

The web server device 120 provides a web page to the client 131 or 132 via the network 110 by using web content 124 stored in the storage device 122. The web server device 120 stores, in an access log 126, various events related to access to web content. The access log 126 may be provided to the web content management server device 140, for example.

The web content management server device 140 may calculate the attention degrees of a plurality of links included in the web content 124 released by the web server device 120, and may store, in the storage device 142, the calculation result as link attention data 144. The web content management server device 140 may calculate the importance degrees of keywords in the web content 124 or keywords in the content indicated by a link in the web content 124, and may store, in the storage device 142, the calculation result as keyword importance data 145. The web content management server device 140 may perform the above-described calculation by using information in the access log 126 and so forth. The storage device 142 may store a click rate predicted value 146 for a link of the web content 124, or web layout data 147, which is a layout of web content customized by a user.

The web server device 120 and the web content management server device 140 may be server devices separated from each other, or may be implemented in a single server device. At least part of the functions or data held by the web server device 120 may be held by the web content management server device 140, and vice versa. A copy of data may be held by both the server devices.

The client 131 may include a device connected to a network, such as a personal computer, a mobile phone, a multifunction phone, or a tablet computer.

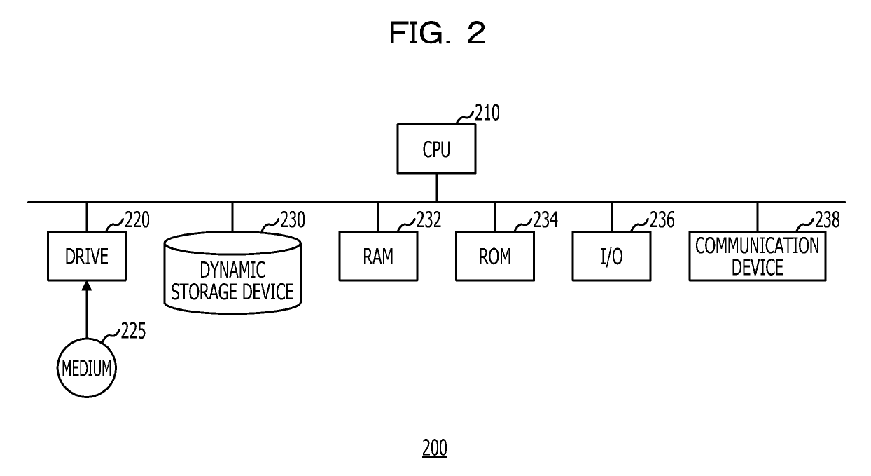

FIG. 2 illustrates an exemplary hardware configuration. The hardware configuration 200 illustrated in FIG. 2 may include the web server device 120 illustrated in FIG. 1 or the web content management server device 140 illustrated in FIG. 1. The hardware configuration 200 includes a central processing unit (CPU) 210, a drive 220 capable of reading data from/writing data on a machine-readable medium 225, such as a compact disc read only memory (CD-ROM), a dynamic storage device 230, such as a hard disk, a random access memory (RAM) 232, a read only memory (ROM) 234, an input and output unit (I/O) 236, and a communication device 238.

An appropriate program may be read and executed by the CPU 210, so that functions may be virtually realized.

The program may be stored in a machine-readable recording medium. The machine-readable recording medium may include a magnetic recording medium, an optical disc, a magneto-optical recording medium, a semiconductor memory, or the like. The magnetic recording medium may include a hard disk drive (HDD), a flexible disk (FD), a magnetic tape (MT), or the like. The optical disc may include a digital versatile disc (DVD), a DVD-RAM, a CD-ROM, a CD-recordable (CD-R), a CD-rewritable (CD-RW), or the like. The magneto-optical recording medium may include a magneto-optical (MO) disk or the like.

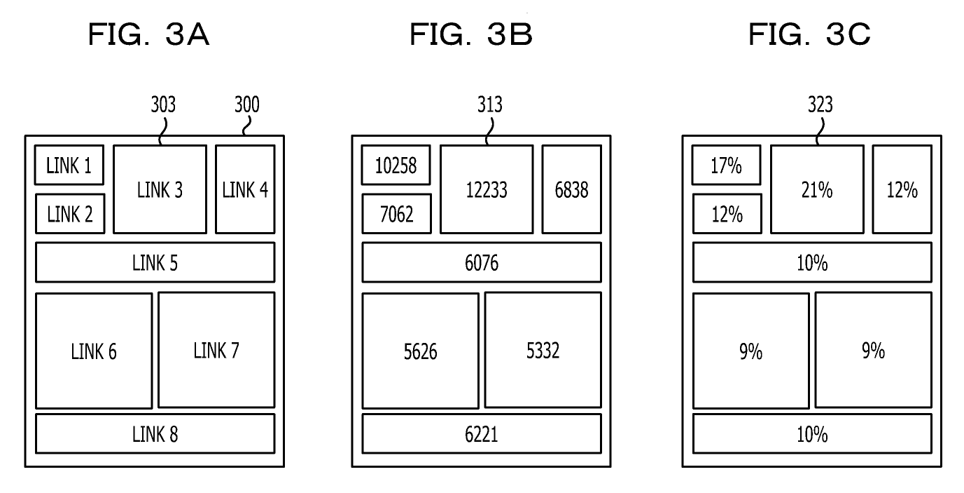

FIGS. 3A to 3C illustrate an exemplary link, an exemplary number of clicks, and an exemplary click rate. In FIG. 3A, links 1 to 8 are arranged in the layout of a web page 300. For example, when a user clicks on a region 303 of the link 3, a browser causes a display to display a page of a uniform resource locator (URL) assigned to the link 3, for example, a hyperlink. A URL embedded in the link may be displayed, or display of a moving image or activation of a desired application may be performed by activating a script or the like.

FIG. 3B illustrates the numbers of clicks in individual regions in the web page 300. For example, the number of clicks in a region 313 corresponding to the link 3 may be 12233. The number of clicks obtained may be the number of clicks performed by all the users who have viewed the web page, the number of clicks performed by a specific user group (for example, male users), or the number of clicks performed by specific users. Information indicating that a specific link has been clicked on may be obtained through analysis of an access log of the web page 300 and a web page linked to the web page 300. Event information may be transmitted to, for example, the web content management server device 140 based on a script for collecting events that occur when a link described on the web page 300 is clicked on. A user may be specified based on a user ID and a password input for displaying a page. A user layer (users included in a group) may be specified on the basis of information that is input at the time of registration of a user ID and a password (sex, date of birth, years of experience of using a PC, type of business, etc.). With the use of a cookie or the like stored in a client machine, an individual may be specified even if the input user ID and password are omitted after the input.

FIG. 3C illustrates click rates in individual regions in the web page 300. For example, the click rate in a region 323 corresponding to the link 3 with respect to the number of clicks in the entire web page 300 may be 21%. The click rate is calculated by, for example, dividing the number of clicks 12233 in the region 313 corresponding to the link 3 by the number of clicks in the entire web page 300. The total sum of the click rates in all the regions may be 100%. In FIG. 3C, the rate of the number of clicks in each region is calculated based on the number of clicks in the entire web page 300. For example, the click rate in each region may be calculated by putting a larger weight on the number of clicks performed by a specific user than a weight put on the numbers of clicks performed by the other users.

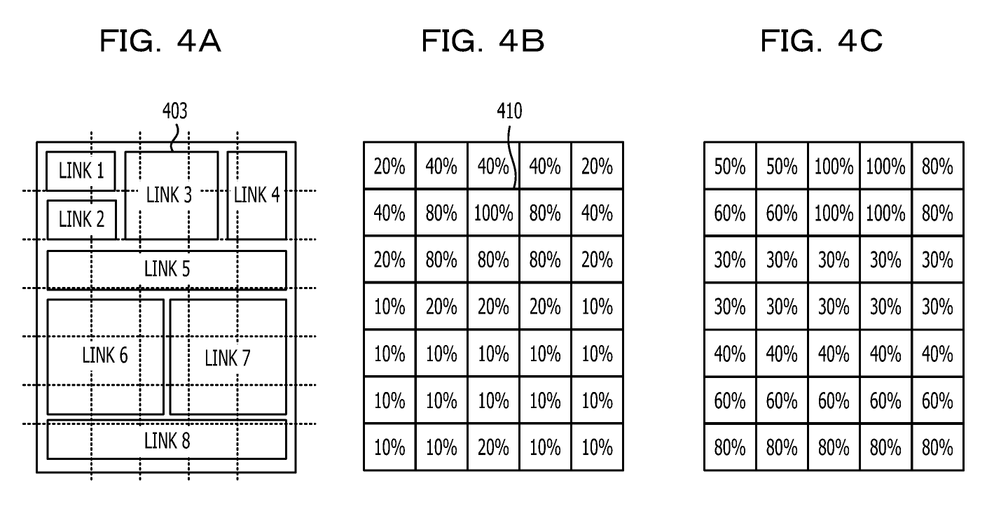

FIGS. 4A to 4C illustrate an exemplary process of calculating predicted values of click rates. In FIG. 4A, a web page is divided into thirty-five equal segments. The web page may be divided to simplify calculation of predicted values of click rates. The number of segments generated through division and the method of division are not limited. Each of the segments generated through division may be referred to as a “square” (the square may not necessarily be a regular tetragon). The segment of each link may be referred to as a “region”, for example, a region 403.

In FIG. 4B, the ease of clicking is indicated as a percentage by using Fitts's UI law. Fitts's UI law defines that the ease of clicking on an object decreases as the distance between the object and the current position of a mouse pointer increases and as the size of the object decreases. In FIG. 4B, a value of 100% is assigned to a square 410, which is the easiest to click on. Values are assigned to the individual squares in accordance with their positions with respect to the square 410, for example, the movement distance of the mouse pointer. The value decreases as the distance from the square 410 increases. A fixed value may be preset as a value indicating the ease of clicking.

In FIG. 4C, a predicted value of a high click rate is assigned to a square having a high contrast ratio between the background color of the page and the color of the square. A higher contrast ratio allows a user to find the square more easily, and the user may be more induced to click on the square.

For example, when the background color is white, a white square (RGB: 0xFFF) is set to 0%, and a black square (RGB: 0x000) is set to 100%. For example, the color of the largest area in a square is set as the color of the square. For example, when the color of a square is 0x800, a value of 50% may be assigned to the square.

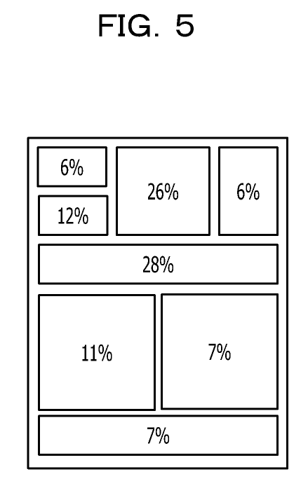

FIG. 5 illustrates an exemplary predicted value of click rates. The predicted values of click rates illustrated in FIG. 5 may be a result obtained through the calculation illustrated in FIGS. 4A to 4C. For example, the degrees of ease illustrated in FIGS. 4B and 4C are multiplied by each other in each square. The values of squares that overlap the region of each link are summed up, and a predicted value of a virtual click rate in the region of each link is obtained. When the region of a link and a square do not completely overlap, the value of an overlapped portion of the square, the value obtained by proportionally dividing the value assigned to the square by the ratio between a portion where the region of the link overlaps the square and a portion where the region of the link does not overlap the square, may be added to the value of the region of the link. The value of the region of each link is multiplied by a constant and is normalized so that the sum of the values of the regions of all the links becomes 100%. FIG. 5 illustrates predicted values of click rates that are based on a distribution of contrast of the web page or the ease of movement of a mouse cursor. The predicted values illustrated in FIG. 5 may be predicted values of click rates that are not based on user's preference.

A user may click on a link represented by a word or picture displayed on a web page. The user may click on a link based on a distribution of contrast of the web page or the ease of movement of a mouse cursor. An influence of a measurement value of clicks that is based on a distribution of contrast of the web page or the ease of movement of a mouse cursor may be reduced to extract user's preference from the measured number of clicks.

For example, the predicted values of click rates illustrated in FIG. 5 are subtracted from the click rates illustrated in FIG. 3C, so that the values of the attention degrees of the individual links, which are closer to the click rates based on user's preference, are calculated. For example, the predicted values of click rates illustrated in FIG. 5 are subtracted from the click rates illustrated in FIG. 3C, so that the click rates based on user's preference are estimated. The click rate based on user's preference may be referred to as the attention degree of the link. The attention degree of the link may be used as an index of the attention degree of the link of the user. The attention degree of the link may be calculated by using the following expression (1).

$${F}_{m} = \frac{{n}_{m}}{{\sum }_{k = 1}^{M} {n}_{k}} - {βα}_{m} \qquad ( 1 )$$

Fₘ represents the attention degree of the m-th link when the number of all links is represented by M, nₘ represents the number of clicks performed on the m-th link, and αₘ represents a predicted value of the click rate of the m-th link. β is a constant that satisfies 0<β.

Subtraction may be performed in the above-described manner (β=1). Subtraction may be performed by putting a desired weight on a predicted value of a click rate by changing the value of β. Another calculation method may be used. The value of β used for calculating the attention degrees of individual links for all users who have accessed a web page may be different from the value of β used for calculating the attention degrees of individual links for specific users.

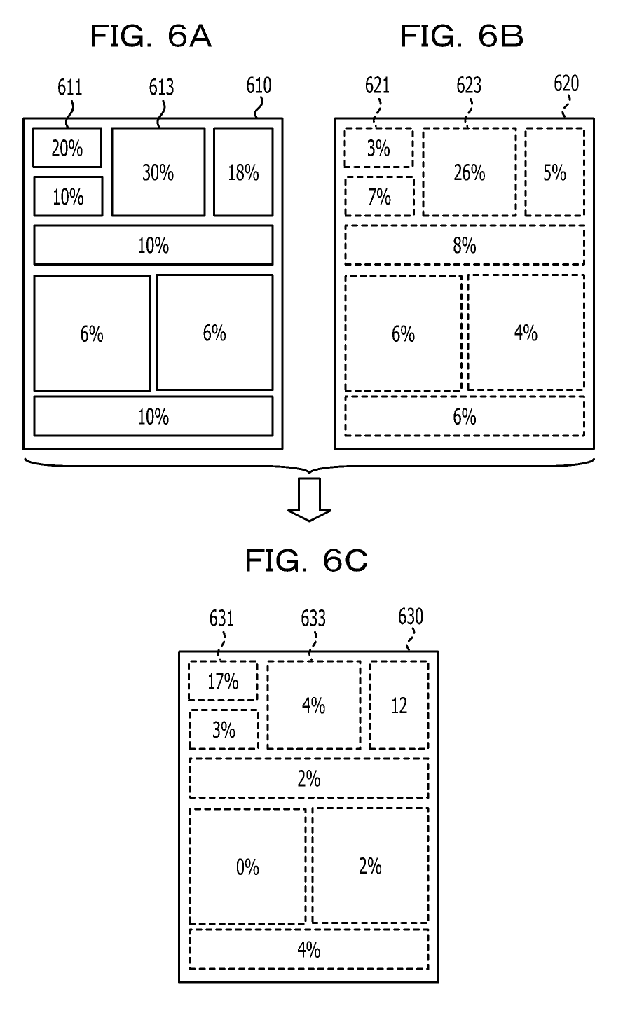

FIGS. 6A to 6C illustrate an exemplary process of calculating an attention degree of a link. In FIGS. 6A to 6C, the attention degrees of links are calculated based on the rates of access to the individual links and predicted values of the rates of access. FIG. 6A illustrates click rates measured in the individual links illustrated in FIG. 3A. FIG. 6B illustrates predicted values of the click rates illustrated in FIG. 5. FIG. 6C illustrates the attention degrees of the links obtained by subtracting the values illustrated in FIG. 6B from the values illustrated in FIG. 6A in the individual links. The calculation may be performed using the above expression (1) or another expression.

For example, the click rate in a region 611 in FIG. 6A corresponding to the link 1 may be 20%. As illustrated in FIG. 6B, the predicted value of the click rate may be 3%. As illustrated in FIG. 6C, the attention degree of the link in a region 631 is calculated as being 17% based on the foregoing values. The region 631 has the highest attention degree in a web page 630. The click rate in a region 613 corresponding to the link 3 is 30%. The predicted value of the click rate in a region 623 is 26%, and thus the attention degree of the link in a region 633 is calculated as being 4%.

The attention degree of content or the like indicated by a link may be recognized based on the attention degrees illustrated in FIG. 6C. The attention degree of a link of a population (for example, male users) may be obtained. The attention degree of a link of specific users may be obtained.

A link having a high attention degree may be moved to a position so that a user may click on the link more easily. A layout for a specific user, for example, “my page” may be set.

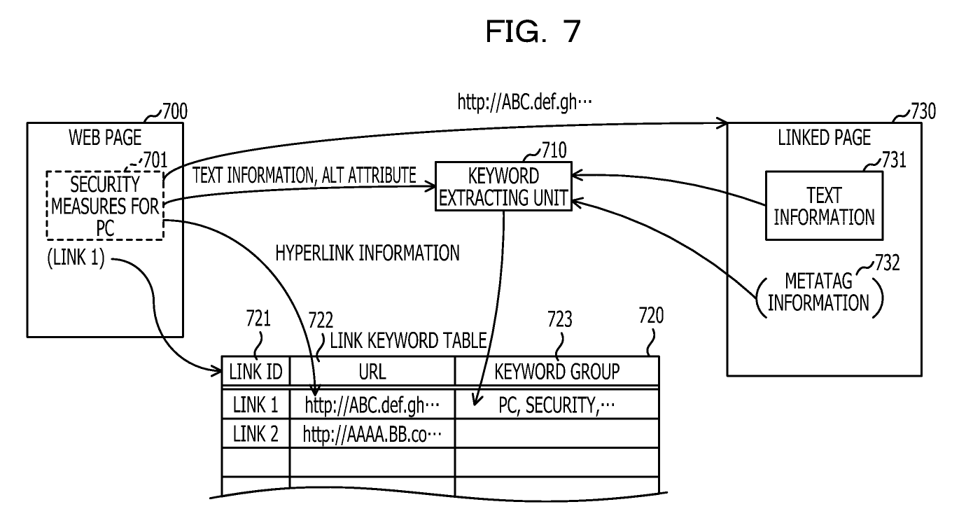

FIG. 7 illustrates an exemplary keyword extraction process. A link 1 (701) is displayed on a web page 700. A keyword group related to the link 1 (701) may be stored in a link keyword table 720. The link 1 (701) is displayed as “security measures for PC” on the web page 700, and “http://ABC.def.gh . . . ” is embedded as URL information of a hyperlink. When the hyperlink is clicked on, a page 730 linked to the foregoing URL is displayed on the display. The web content management server device 140 or a keyword extracting unit 710 inputs the foregoing URL “http://ABC.def.gh . . . ” to a URL entry column 722 corresponding to “link 1” in a link ID column 721 in the link keyword table 720. The keyword extracting unit 710 may extract a keyword from text information or information including an alt attribute of the link 1 (701), and store the extracted keyword in a keyword group entry column 723. When the link 1 is information other than text information, for example, a photograph, information about an alt attribute or the like may be used. The keyword extracting unit 710 may analyze text information 731 or metatag information 732 on the linked page 730, extract a keyword, and store the keyword in the keyword group entry column 723.

For example, in order to extract a Japanese keyword, morphological analysis may be performed, and change of conjugation or an algorithm of narrowing down candidate keywords, such as a list of unnecessary words, may be used.

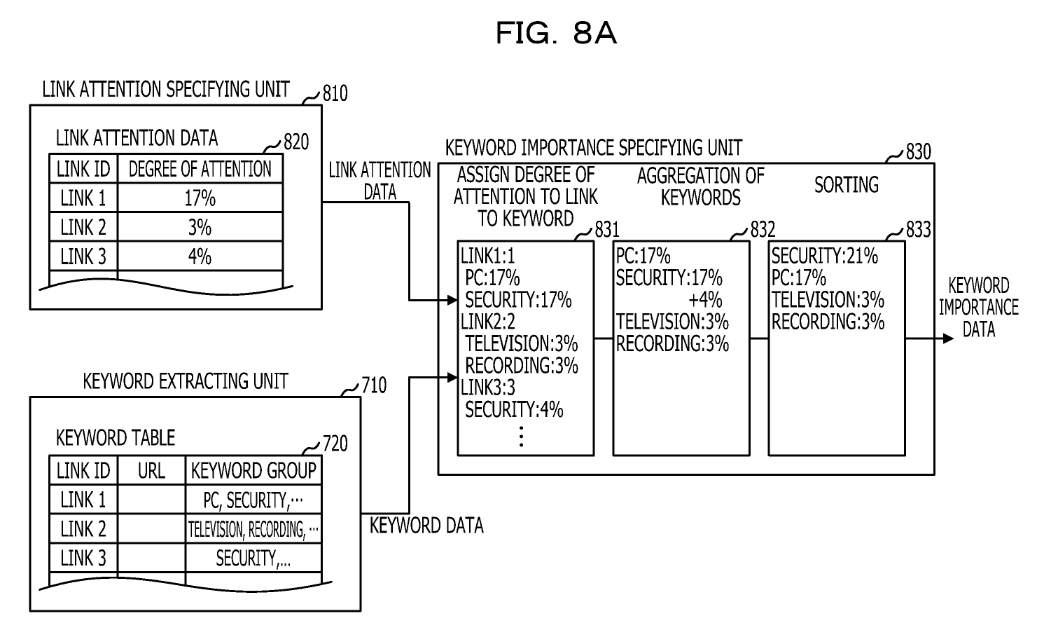

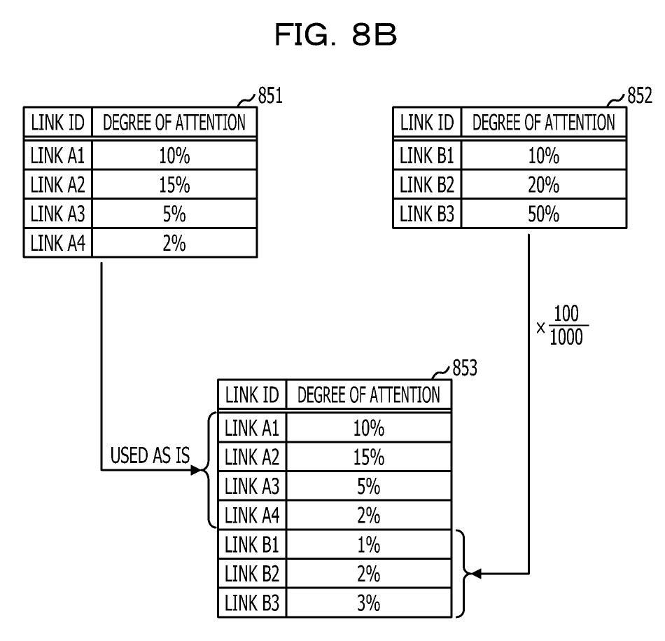

Keyword groups corresponding to the individual links in the web page 700 are stored in the link keyword table 720. In the link keyword table 720, the degree of importance may be assigned to each keyword by a keyword importance specifying unit 830 (see FIG. 8A), for example.

FIGS. 8A and 8B illustrate an exemplary process of specifying a degree of an importance of keyword. A link attention specifying unit 810 specifies the attention degree of the link of each link ID, and outputs link attention data 820. The attention degree of the link may be obtained through the calculation illustrated in FIGS. 6A to 6C.

The keyword extracting unit 710 extracts keywords corresponding to the individual links. Keywords may be extracted by the keyword extracting unit 710 illustrated in FIG. 7.

The link attention data 820 supplied from the link attention specifying unit 810 and the data of the link keyword table 720 are input to the keyword importance specifying unit 830.

The keyword importance specifying unit 830 assigns the attention degree of a link to each keyword by using a link ID (831). The attention degrees of links about the same keyword are summed up, and the keywords are aggregated (832). The keywords are sorted in the descending order of the total value of the attention degrees of the corresponding links (833).

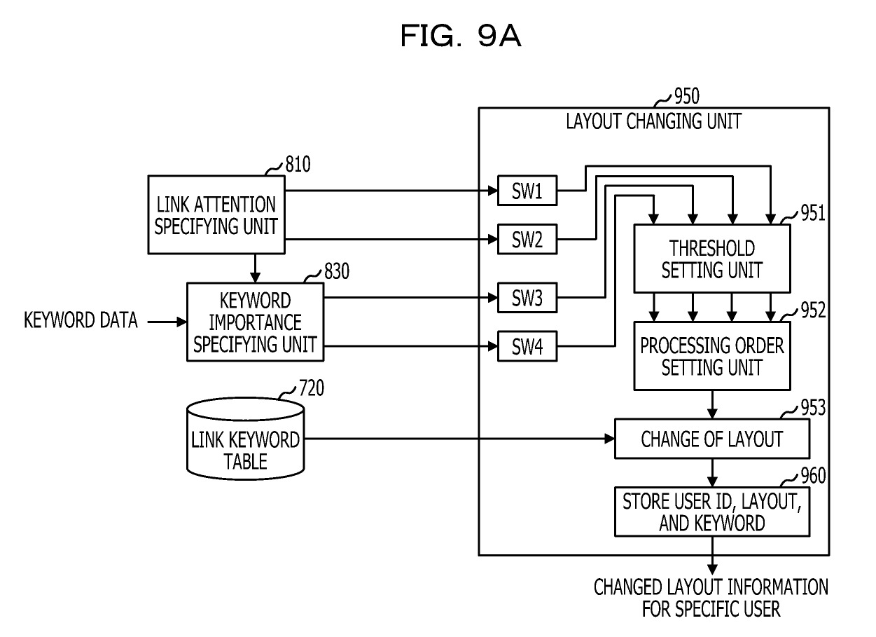

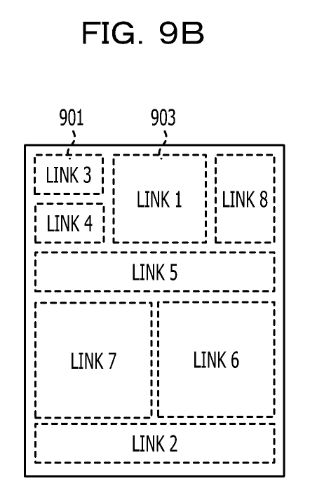

Keyword importance data, in which keywords are arranged in the order of the degree of importance, is generated and output. The keyword importance data may be used by a layout changing unit 950 (see FIG. 9A). As the keyword importance data, keyword importance data for specific users, users belonging to a specific group (for example, male users), or all users who have accessed the web page is obtained. Likewise, link attention data for various users may be obtained.

FIG. 8B illustrates an exemplary normalization of an attention degree of a link. In FIG. 8B, a plurality of pages are handled. For example, link attention data 851 of a web page A and link attention data 852 of a web page B are combined into link attention data 853. For example, the total number of clicks in the web page A may be 1000, and the total number of clicks in the web page B may be 100. In order to use the attention degrees of the links in the web page A, normalization may be performed by multiplying the attention degrees of the links in the web page B by 100/1000, which is the ratio between the total numbers of clicks in the web page A and web page B. The link attention data of the web page A and the link attention data of the web page B may be combined so as to be used in the subsequent process.

The layout of a web page may be changed by using link attention data and keyword importance data. Change of the layout of a web page may not be executed in real time when a specific user accesses the web page. For example, the web content management server device 140 may perform a process by using log information or event information, and store a process result of layout information of the web page.

FIG. 9A illustrates an exemplary process of changing a layout of a web page. A web page layout of a specific user may be changed. The link attention specifying unit 810 and the keyword importance specifying unit 830 may output information about various users. In FIG. 9A, the link attention specifying unit 810 may output link attention data 941 of a specific user and link attention data 942 of a plurality of users belonging to a group to the layout changing unit 950. The keyword importance specifying unit 830 may output keyword importance data 943 of a specific user and keyword importance data 944 of a plurality of users belonging to a group to the layout changing unit 950. The two data lines extending from the link attention specifying unit 810 or the two data lines extending from the keyword importance specifying unit 830 may be combined into a single line. Two pieces of data may be transmitted in series.

The layout changing unit 950 receives inputs from the link attention specifying unit 810 and the keyword importance specifying unit 830 by using SW1 to SW4 having a switch function. For example, a desired input may be selected based on a setting input of a specific user. For example, the SW1 and SW3 may be switched off, and the data about the specific user may not be considered. The layout of the web page of the specific user may be changed to a layout in which preference of the plurality of users belonging to the group is reflected. The SW2 and SW4 may be switched off, and the layout may be changed to a layout of a web page in which preference of the specific user is reflected.

A threshold setting unit 951 may set a threshold for each of the link attention data 941, the link attention data 942, the keyword importance data 943, and the keyword importance data 944 based on the input setting performed by a user, for example. Link attention data having a attention degree equal to or higher than a threshold, or keyword having a degree of importance equal to or higher than a threshold may be used in the subsequent layout change process. In the information about a specific user, whether or not the number of browses of a web page or the number of clicks is equal to or larger than a threshold may be checked. For example, the number of clicks may be supplied to the threshold setting unit 951. When the number of clicks is smaller than the threshold, the data parameter may be small. In this case, obtained data may not be used, and setting may be performed so that the layout is not changed.

A processing order setting unit 952 may set the processing order of pieces of input data based on the input setting performed by a user, for example. For example, the data of the users belonging to the group may be processed first, and then the data of the specific user may be processed. The data of the specific user is processed later, and thus preference of the specific user may be reflected in the layout.

A default value may be set for the input setting. The setting may be performed by an operator who manages a web page. In the process of change of layout 953, a link having a high attention degree or a link related to a keyword having a high degree of importance is placed at an easily accessed position, or the position of such a link is changed with the position of a link having a low attention degree or a link related to a keyword having a low degree of importance. In the process of the change of layout 953, the relationship between links and keywords stored in the link keyword table 720 may be used.

A page suitable for user's preference, including stocked links, may be selected, and a web page may be created accordingly. A search result of a keyword having a high degree of importance obtained by a search engine may be displayed in a region of the web page.

The data of the layout may be stored together with the user ID of the specific user (or user group ID), or together with a keyword liked by the specific user (or specific user group) (960).

FIG. 9B illustrates an exemplary layout of a web page. For example, the layout of the web page illustrated in FIG. 3A may be changed through the change of layout illustrated in FIG. 9A. For example, as illustrated in FIG. 6C, the link 1 may have a attention degree of 17%. As illustrated in FIG. 6C, the link 3 may have a attention degree of 4%. In FIG. 9B, the layout of the web page is changed so that the links in regions 901 and 903 are exchanged and the link 1 is positioned in the region 903. As illustrated in FIG. 6B, the region 903 has a large predicted value of a click rate, for example, is easy to click on. The link 1 having the highest attention degree in the web page is arranged in the region 903. A user-friendly my web page is created by changing the layout. The my web page may be provided to a corresponding user.

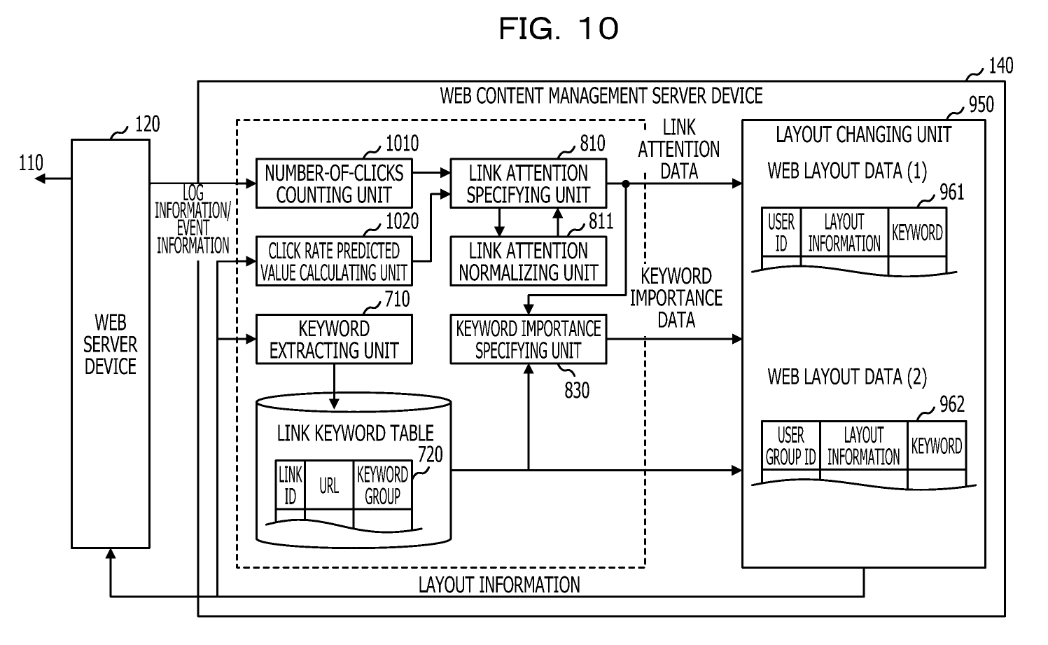

In the layout changing unit 950, a region where the layout is not to be changed may be specified. FIG. 10 illustrates an exemplary system. Log information and event information supplied from the web server device 120 are input to a number-of-clicks counting unit 1010 in the web content management server device 140, and the numbers of clicks performed on individual links are counted. The numbers of clicks are transmitted to the link attention specifying unit 810.

A click rate predicted value calculating unit 1020 calculates predicted values of click rates of the individual links by using the layout information supplied from the layout changing unit 950. The predicted values are supplied to the link attention specifying unit 810.

The link attention specifying unit 810 specifies the attention degrees of the individual links. Data of the attention degrees of the links (hereinafter referred to as link attention data) specified by the link attention specifying unit 810 is supplied to the layout changing unit 950. The link attention data may be used for web design as data for creating a web page.

A link attention normalizing unit 811 combines pieces of link attention data obtained from a plurality of web pages. For example, the process illustrated in FIG. 8B may be performed. The link attention normalizing unit 811 adjusts the pieces of link attention data by using the total number of clicks in each web page, and combines the attention degrees of the links existing in the plurality of web pages. The combined data is returned to the link attention specifying unit 810.

The keyword extracting unit 710 may execute the process illustrated in FIG. 7 by using web layout information or data of a web page. The keyword extracting unit 710 extracts keywords of the individual links and stores the extracted keywords in the link keyword table 720.

The keyword importance specifying unit 830 specifies the degrees of importance of individual keywords by using the information stored in the link keyword table 720 and the link attention data. The keyword importance specifying unit 830 may execute the process of specifying the degrees of importance of keywords illustrated in FIG. 8A.

The layout changing unit 950 changes the layout of a web page by using the link attention data, keyword importance data, or the information stored in the link keyword table 720. The layout changing unit 950 may execute the process of changing a web page layout illustrated in FIG. 9A. The layout changing unit 950 may store web layout data and web layout data, which include layout information and so forth.

The layout information of the web page changed by the layout changing unit 950 may be used in the web server device 120, the click rate predicted value calculating unit 1020, or the keyword extracting unit 710.

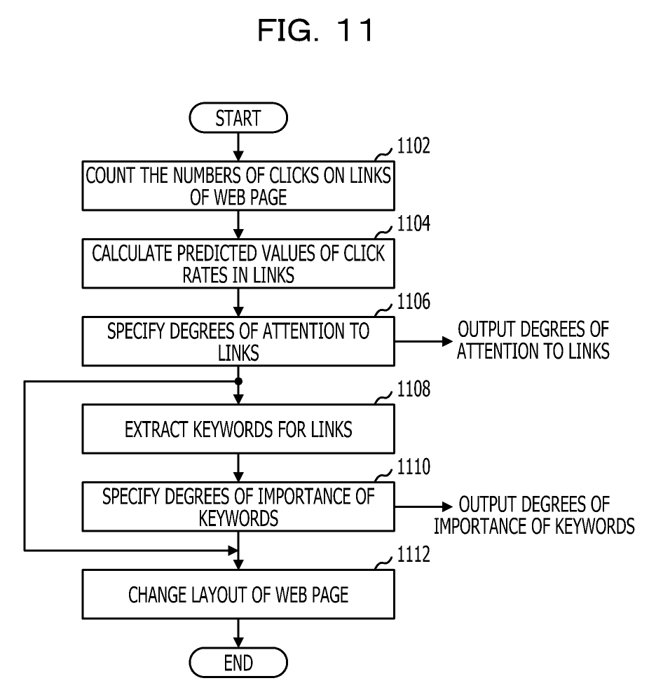

FIG. 11 illustrates an exemplary process. The process illustrated in FIG. 11 may be executed by the system illustrated in FIG. 10. The order of the operations in the process may be changed.

In an operation 1102, the numbers of clicks performed on individual links of a web page by a user are counted.

In an operation 1104, predicted values of click rates in the individual links are calculated. The calculation may be performed based on a distribution of contrast of the web page or the ease of movement of a mouse cursor.

In an operation 1106, the attention degrees of the individual links are specified. The attention degrees may be specified based on the numbers of clicks performed on the individual links of the web page and the predicted values of click rates. The attention degrees of the individual links may be output to the outside.

In an operation 1108, keywords for the individual links may be extracted. The keywords may be extracted from text information of the links or an alt attribute. The keywords may be extracted based on analysis of text information or metatag information of a linked page.

In an operation 1110, the degrees of importance of the individual keywords are specified. Information about the degrees of importance of the individual keywords may be output to the outside.

In an operation 1112, the layout of the web page may be changed. The layout may be changed based on at least one of the attention degrees of the individual links and the degrees of importance of the individual keywords.

The acquisition of the attention degrees of the links and the degrees of importance of the keywords, and the change of the layout of the web page may not be performed in real time. For example, the web content management server device 140 may perform a process at a desired timing or interval based on information including log information or event information about access to the web page, and may store the process result. Link attention data, keyword importance data, or web page layout information may be read out from a storage device at a desired timing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A server device comprising:
a number-of-instructions counting unit to count a number of instructions of a user for a link of a web page;
an instruction rate predicted value calculating unit to calculate a predicted value of a rate of the instructions;
a link attention specifying unit to specify an attention degree of the link based on the number of instructions and the predicted value of the rate; and
a layout changing unit to change a layout of the web page based on the attention degree of the link.

2. The server device according to claim 1, further comprising:
a keyword extracting unit to extract at least one keyword related to the link; and
a keyword importance specifying unit to specify an importance degree of the keyword based on the attention degree of the link and the keyword,
wherein the layout changing unit changes the layout of the web page based on at least one of the attention degree of the link and the importance degree of the keyword.

3. The server device according to claim 1,
wherein the attention degree of the link is calculated using
$${F}_{m} = \frac{{n}_{m}}{{\sum }_{k = 1}^{M} {n}_{k}} - {βα}_{m} \qquad ( 1 )$$
Fₘ representing the attention degree of an m-th link when a number of the links is represented by M,
nₘ representing a number of instructions of the m-th link,
αₘ representing the predicted value of the rate at of the instructions of the m-th link, and
β representing a constant that satisfies 0<β.

4. The server device according to claim 1,
wherein the predicted value is set based on at least one of an area of the link, a position of the link, and a contrast ratio to a background of the link.

5. The server device according to claim 2,
wherein the at least one keyword is extracted from information including a character string of the link or content indicated by the link.

6. The server device according to claim 1,
wherein the user corresponds to one of a plurality of users, a specific user, a female user, a male user, a user in a specific age group, and a user who accesses the web page in a specific time slot.

7. A method executed by a computer, the method comprising:
counting a number of instructions made by a user for a link of a web page;
calculating a predicted value of a rate of the instructions for the link;
specifying an attention degree of the link based on the number of instructions and the predicted value of the rate; and
changing a layout of the web page based on the attention degree of the link.

8. The method according to claim 7, further comprising:
extracting at least one keyword related to the link; and
specifying an importance degree of the keyword based on the attention degree of the link and the keyword,
wherein the layout of the web page is changed based on at least one of the attention degree of the link and the importance degree of the keyword.

9. The method according to claim 7,
wherein the attention degree of the link is calculated using
$${F}_{m} = \frac{{n}_{m}}{{\sum }_{k = 1}^{M} {n}_{k}} - {βα}_{m} \qquad ( 1 )$$
Fₘ representing the attention degree of an m-th link when a number of the links is represented by M,
nₘ representing a number of instructions of the m-th link,
αₘ representing the predicted value of the rate at of the instructions of the m-th link, and
β representing a constant that satisfies 0<β.

10. The method according to claim 7,
wherein the predicted value is set based on at least one of an area of the link, a position of the link, and a contrast ratio to a background of the link.

11. The method according to claim 8,
wherein the least one keyword is extracted from information including a character string of the link or from content indicated by the link.

12. The method according to claim 7,
wherein the user corresponds to one of a plurality of users, a specific user, a female user, a male user, a user in a specific age group, and a user who accesses the web page in a specific time slot.

13. A server device comprising:
a number-of-instructions counting unit to count a first number of first instructions of a first user for a link of a web page, and a second number of second instructions of a second user for the link of the web page, the second user being included in a group;
an instruction rate predicted value calculating unit to calculate a predicted value of a rate of each of the first instructions and the second instructions;
a link attention specifying unit to specify an attention degree of the link for each of the first user and the second user based on one of the first number and the second number and the predicted value of one of the first user and the second user; and
a layout changing unit to change a layout of the web page for the second user based on the attention degree for the second user.

14. The server device according to claim 13, further comprising:
a keyword extracting unit to extract at least one keywords related to the link; and
a keyword importance specifying unit to specify an importance degree of the keyword for the first user and the second user based on the attention degree of attention to each of the links and the keyword,
wherein the layout changing unit changes the layout of the web page based on at least one of the attention degree of the link and the importance degree of the keyword.
